(19) United States
(12) Patent Application Publication
(10) Pub. No.: US 2005/0080733 A1
(43) Pub. Date: Apr. 14, 2005

(54) Secure internet payment process

(75) Inventor: James L. McIntosh, Lewisville, TX (US)

Correspondence Address: John E. Vandigriff, Suite 200, 190 N. Stemmons Frwy., Lewisville, TX, 75067, US

(73) Assignee: Mer-Tec, Inc.

(21) Appl. No.: 10/683,619

(22) Filed: Oct. 14, 2003

(51) Int. Cl. G06F 17/60

(52) U.S. Cl. 705/40; 705/67

(57) ABSTRACT

A method of purchasing digital content over the Internet is based on embedding necessary information called attributes in or with the digital content (such as the price and who is the seller), then preventing the user from accessing the content until the user is authorized to do so. The concept of a self authorizing self destructing digital content eliminates the need for Merchant sites to support payment processing as a function or extension of their web server applications. Instead of relying on a web server based payment processing method, the digital content itself is modified to invoke software resident on the users computer. When a user selects an item of digital content that they wish to purchase, it is downloaded to the users computer. There the instructions and or software programs embedded in the digital content will interact with a third party software to authorize the purchase.

### FIELD OF THE INVENTION

The invention relates to payment processes, and more particularly to a secure payment process for making anonymous purchases from web sites for, including purchases of less than one dollar, without the use of credit cards.

### BACKGROUND OF THE INVENTION

Today the purchase of digital content is generally accomplished by either a subscription to a particular merchant web site or a proprietary third party authorization service. Both methods today require either extensive development and processing on the merchants web server, or outsourcing the web site to a company that operates a proprietary system with some payment processing capabilities. Historically, it has been necessary to somehow integrate payment processing with the web shopping experience. Either way it is implemented, the payment processing associated with purchasing digital content is a function of and/or complex extension to a web server application, and the authorization processing is normally performed in advance of downloading the content to view the document or play the song, etc.

Two common payment methods on the internet today are phone orders and credit card orders. In the use of Phone orders, many companies are only using the Web to advertise the company and its products. If a person wants to order an item they are given a 1-800 number to call. An operator processes the order just as if the customer saw an advertisement on TV or in a magazine. For credit card orders, the customer use a web based CGI form to fill out their order information and provide their credit card number. The early Netscape browser introduced Secure Sockets Layer (SLL)technology to protect the card numbers. Users are often advised if they are using an older browser that does not have SLL built in, to phone in their order. Still, many people are very concerned about internet security and are reluctant to send their card numbers with their large credit limit into cyberspace.

Additional background information, including an overall basic review of several payment systems, is found and described at the web site http://www witiger.com/ecommerce.paymentmatrix.htm.

### SUMMARY OF THE INVENTION

Today the purchase of digital content is generally accomplished by either a subscription to a particular merchant web site or a proprietary third party authorization service. Both methods today require either extensive development and processing on the merchants web server, or outsourcing the web site to a company that operates a proprietary system with some payment processing capabilities. Historically, it has been necessary to somehow integrate payment processing with the web shopping experience. Either way it is implemented, the payment processing associated with purchasing digital content is a function of and/or complex extension to a web server application, and the authorization processing is normally performed in advance of downloading the content to view the document or play the song, etc.

The present invention, entitled The Electrum Payment Process (EPP), requires no software development or implementation at/on/to the merchant site's web server(s). EPP is a new approach to this concept and is based on embedding necessary information called attributes in or with the digital content (such as the price and who is the seller), then preventing the user from accessing the content until the user is authorized to do so. The concept of a self authorizing self destructing digital content eliminates the need for Merchant sites to support payment processing as a function or extension of their web server applications. Instead of relying on a web server based payment processing method, the digital content itself is modified to invoke software resident on the users computer. When a user selects an item of digital content that they wish to purchase, it is downloaded to the users computer. There the instructions and or software programs embedded in the digital content will interact with a third party application (like Adobe Acrobat or Real Player, or EPP Plug-In) and the EPP Authorization Client to authorize the purchase. If the authorization is successful, the third party application will then process the digital content in its normal fashion and the merchant will receive payment from the EPP Back-End financial settlement processing. If the authorization fails, the digital content self destructs by deleting itself.

In the terms “Electrum Payment Process” and “Secure Castle” are terms use in describing the invention, where “Electrum Payment Process” is the process of the invention and “Secure Castle” is the commercial web site that provides the “Electrum Payment Process” service.

### BRIEF DESCRIPTIONS OF THE DRAWINGS

FIG. 1 is a block diagram showing the steps in setting up a web site agreement with Secure Castle;

FIG. 2 is a block diagram showing the steps at a User (web site that utilizes “Electrum Payment Process”, goes through in setting up an account with Secure Castle;

FIG. 3 is a block diagram showing the process steps that a customer implements to be able to make purchases using the “Electrum Payment Process”; and

FIG. 4 is a block diagram illustrating the Secure Castle Payment process.

### DESCRIPTION OF A PREFERRED EMBODIMENT

The “Electrum Payment Process”, according to the present invention, is a distributed computer software application that creates a process or methodology for purchasing digital content or other small cost items from Internet web sites.

Although many of the individual concepts and technologies incorporated in the process may exist in some form today, the Electrum Payment Process combines them into a new way to process payments for and control access to digital content or other goods sold from merchant web sites.

As used in the present invention, the term “user” refers to a person connected to the Internet whose actions are solely for their own use, enjoyment, or benefit. The term “Merchant Site” refers to any web site that provides digital content for sale to users. The term “digital content” refers to any binary or text data that can be downloaded to a user's computer to be viewed, played, executed, etc. as a document, song, or movie, usually through a third party application such as Adobe Acrobat or Microsoft Real Player.

The Electrum Payment Process (EPP) separates the “payment processing” from the web server applications which provide digital content or other goods for sale. In so doing, the user only has to create one account that can be used at any web site that subscribes to (contracts with) the EPP service. Once the user has subscribed, merchant sites can simply modify the digital content they wish to sell and publish it on their site for download. Any user can download the digital content but only authorized EPP users can purchase and subsequently use it as intended. The current payment processing models require payment before downloading, which dictates the integration of payment processing with the web server applications in order to determine and control if something can be downloaded. Some of the advantages of the present invention are:

1. Dramatically reduces the cost of selling digital content or other products from web sites by eliminating the need for the web site to implement an integrated payment system with their site. It enables any web site to publish digital content for sale and receive payment for each purchase.

2. Protects users credit card number and other sensitive personal data by not sending it to the merchant over the Internet.

3. The user can make micro purchases (purchase for small amounts that are not cost effective for credit cards, checks, etc. due to the cost of processing). This means that any web site can sell content that today they either give away or don't even publish.

4. Provides a single methodology for making purchases regardless of the tender actually used for the purchase (i.e. credit card, electronic check, cash account, etc).

5. Optionally allows the user to accept or reject each purchase made from a web site as it occurs thus allowing the Internet user to personally control any charges to their account.

6. Provides a monthly statement of all account activity regardless of which web sites originated the charge to a users account. Purchases and therefore account details are limited to Merchants or Web sites participating in the Electrum program.

7. Allows users to maintain control over the amount of risk they are willing to take when making purchases over the Internet based on the amount they choose to place in their Electrum account.

8. Allows reporting to the merchant for purchase analysis, demographic analysis, and customer profiles from a single source.

9. Users only have to maintain one account that can be used at any participating merchant site.

10. Users remain anonymous to merchant sites.

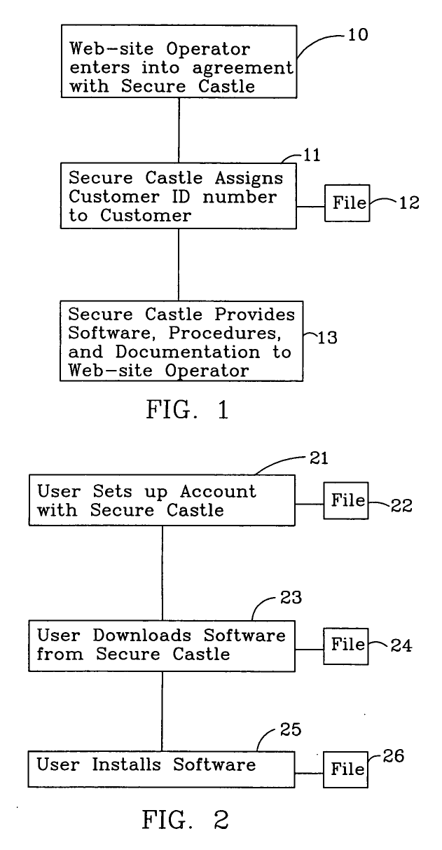

FIG. 1 shows the process wherein a Web site owner/merchant enters in to an agreement with Secure Castle 10. Secure Castle assigns a customer ID to the Customer 11 from a data base 12. The necessary software, procedures, and documentation is either downloaded by the customer, or otherwise obtained by mail or from Secure Castle web site 13.

FIG. 2 shows a new user set-up process. The user logs onto Secure Castle web site and sets up an account 21. During the setup process, the user is give an account number after creating a login, password and pin (personal identification number). This information is stored in a Secure Castle file 22. The account can be funded with a credit card, check or cash (received later).

After the account has been established, the user then downloads 23 the Electrum software where it is stored 24. The downloaded software is then and installed 25 on the user computer and stores it as a program 26 that interacts with the Secure Castle web site and server when a purchase is made. This step stores an encrypted form of the user's account number along with other information used for electrum authorizations, such as a digital certificate.

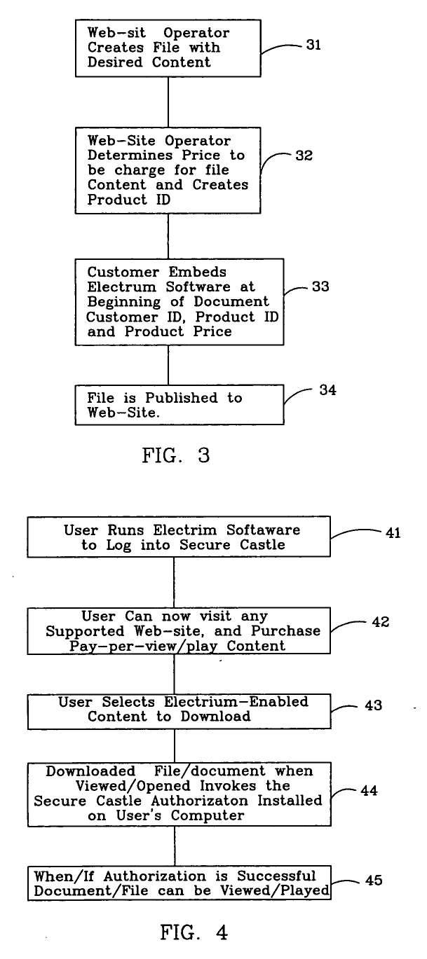

In FIG. 3, the Customer, who wishes to sell products, which may include, for example, documentation (such as e-books and e-literature), music and video files, and computer software files, creates on his web site files 31 with the desired content. The customer determines the price to be charged for the content, and creates a product ID 32. Next, the Customer embeds the electrum software in the content of the document, along with the customer ID, product ID and price 33. The Customer then publishes the product to their web site 34.

Use of the secure Castle Payment system is outlined in FIG. 4. The user runs the Electrum program to log into Secure Castle 41. This step is a prerequisite to any purchase of digital content. Upon successful login, A Secure Castle virtual account number is generated and stored on the users computer for the duration of the logged-in session. The session lasts only as long as the user is logged in and the virtual account number is only valid while the session is valid.

During the user setup, the user selects “max session” value up to one hour in case no logout of session occurs. This logs user out in case the user “forgets” to log out, or something interrupts the session. The user may also designate a “rating” of the content to prevent children from downloading and viewing adult content. Another feature available is to specify if there may be multi-viewing. With multi-viewing, the content may be viewed or downloaded more than one time, or from different computers.

While a user is logged in, the window used for logging in on remains open on the user's computer. During the session, any electrum purchase is displayed to the user in the login window as it occurs. The user can now visit any supported web site and purchase pay-per-view/play content 43, or down loaded supported products 44.

When the a document is viewed, played, or downloaded 45, Secure Castle authorization program installed on user's computer is invoked. The Secure Castle authorization program accepts the customer ID, product ID, and amount of intended purchase. User is then prompted for the user PIN, and read account information, including the temporary virtual account number. All of this information collectively becomes an authorization request. If authorization is successful 45, product can be viewed, played, or executed.

The buying and selling digital content requires both buyers and sellers to be known to the system, but not necessarily to each other. Accordingly both buyers and sellers utilizing EPP must be registered with EPP by creating an EPP account of the appropriate type. The accounts are structured differently based on the way it will be used and what information is necessary.

One basic principle of the method is the creation and use of temporary virtual account numbers (VAN). These account numbers are generated when a user logs in to the EPP Host with the EPP Login Client and are stored on the user's computer. When a user down loads digital content they want to purchase, the EPP Authorization Client retrieves the VAN and constructs an authorization transaction that is electronically sent to the EPS Host for payment authorization. The authorization transaction includes the VAN, user entered information (such as a PIN number), and information from the attributes of the digital content (such as price, seller customer ID, and product ID). If the authorization is successful, the third party application will proceed to process the digital content to be downloaded as it normally would. When the EPS Host receives an authorization request, it validates the information against the EPS Database and determines if the user has sufficient funds available for the purchase.

The Electrum Payment Process relies on third party applications (such as adobe Acrobat in the case of documentation) to sense that the digital content contained in a document or file should first be purchased before the user is allowed to view or play the content. This is accomplished at the point the file or data stream containing digital content is created. To use Adobe PDF files as an example, Adobe Acrobat allows users of their application special instructions inside a document when it is created. The Electrum Payment Process will utilize these capabilities to invoke the Electrum client software when an application like Adobe Acrobat reader attempts to display a downloaded PDF file that has been enabled for EPP. If the EPP authorization processing fails, the Acrobat Reader program is instructed to discard the digital content. For other applications that don't support embedding instructions into the actual content that they are designed to play, show, or execute, there are two alternatives. First, the third party application can modify their programs to support invoking the Electrum client software directly from within their application. A third alternative is to utilize the EPP utility program “EPS PayMaker” to convert any digital content into an encrypted proprietary EPP file format. When the EPP formatted file is downloaded by a web browser, the web browser will sense that this is an EPP file and invoke the EPP Plug-In application that will then invokes the EPP Authorization Client software to (1) purchase the content, (2) decrypt it, and then (3) pass it to the appropriate third party application.

1. A method for purchasing digital content over the internet, comprising the steps of:
a user downloading the digital content;
a user initiating the use of the digital content;
utilizing a program on user's computer previous installed to determine if user is to be authorized by payment to use the digital content; and
when user is found to be authorized, initiating payment for the digital content to a third party, and authorizing use of digital content by user.

2. The method according to claim 1, wherein the digital content is destroyed by the program on user's computer previously install if user is not authorized to use the digital content.

3. The method according to claim 1, wherein user is assigned an ID number for identification and for use in authorization.

4. The method according to claim 1, wherein owner of the digital content and the third party enter into an agreement for third party to authorize and collect payment for the digital content, and third party collects payment from an account previously setup between third party and user.

5. The method according to claim 1, wherein user downloads software from third party to establish a user account and to provide the means for authorizing use of downloaded digital content and payment for the digital content.

6. The method according to claim 5, wherein user installs software downloaded from third party and sets-up user account prior to downloading any digital content.

7. A method for purchasing digital content over the internet, comprising the steps of:
a user downloads software from a third party to set up a user account and means for authorization and payment of purchased digital content;
a user downloading the digital content;
a user initiating the use of the digital content;
utilizing the downloaded software on user's computer previous installed to determine if user is to be authorized by payment to use the digital content; and
when user is found to be authorized, initiating payment for the digital content to a third party, and authorizing use of digital content by user.

8. The method according to claim 7, wherein the digital content is destroyed by the program on user's computer previously install if user is not authorized to use the digital content.

9. The method according to claim 7, wherein user is assigned an ID number for identification and for use in authorization.

10. The method according to claim 7, wherein owner of the digital content and the third party enter into an agreement for third party to authorize and collect payment for the digital content, and third party collects payment from an account previously setup between third party and user.

11. The method according to claim 7, wherein user installs software downloaded from third party and sets-up user account prior to downloading any digital content.

12. The method according to claim 2, wherein user logs onto third party website to download the digital content to be purchased.

13. The method according to claim 7, wherein an owner of digital content to be purchased and downloaded by user embeds in digital content product, and owner ID, product ID and product price.

14. The method according to claim 7, wherein authorization to use digital content extends to digital content provided my a plurality of product owners.

15. The method according to claim 7, wherein the user can specify the rating of the digital content which may be view and downloaded.

16. The method according to claim 7, wherein the user can purchase multi-viewing and downloading of the digital content.
